(19) United States
(12) Patent Application Publication
(10) Pub. No.: US 2012/0254470 A1
(43) Pub. Date: Oct. 4, 2012

(54) CONNECTOR APPLIED TO A PORTABLE DEVICE AND METHOD OF CONNECTING A PORTABLE DEVICE WITH AN EXTERNAL DEVICE

(76) Inventors: Ming-Hong Kuo, Hsinchu City (TW); Li-Fu Huang, Miaoli County (TW); Lien-Sheng Yang, Hsinchu City (TW)

(21) Appl. No.: 13/421,881

(22) Filed: Mar. 16, 2012

(30) Foreign Application Priority Data
Apr. 1, 2011 (TW) 100111685

(51) Int. Cl. H04W 84/02

(52) U.S. Cl. 709/250

(57) ABSTRACT

A connector applied to a portable device includes a wireless module, a connection module, at least one connection socket, a controller, and a memory. The wireless module is used for establishing a wireless connection between the portable device and the connector. The connection module is used for communicating with an external device. The at least one connection socket is used for connecting the connection module with the external device. The controller is coupled between the wireless module and the connection module for transmitting data between the wireless module and the connection module and executing commands to control the wireless module and the connection module. The memory is used for storing the commands required for the controller and is used as a data register to boost a data transmission rate between the portable device and the external device.

### BACKGROUND OF THE INVENTION

1. Field of the Invention

The present invention is related to a connector and operation method thereof, and particularly to a connector and operation method thereof that utilize a wireless module to establish a wireless connection between a portable device and the connector, and utilize a connection module and at least one connection socket to establish a physical connection between an external device and the connector.

2. Description of the Prior Art

Please refer to FIG. 1. FIG. 1 is a diagram illustrating operation of a connector 100 according to the prior art. As shown in FIG. 1, the connector 100 utilizes a connection plug 102 to connect the connector 100 with an external device 104 (such as a desktop computer or a notebook), and utilizes a connection module 1002 of the connector 100 to communicate with the external device 104. In addition, the connector 100 can utilize a wireless module 1004 of the connector 100 to establish a wireless connection with the Internet and/or another device with a wireless module.

Though a user can utilize the connector 100 to connect the external device 104 with the Internet and/or another device with the wireless module anytime and anywhere, not all devices have a connection socket into which the connection plug 102 of the connector 100 can be plugged (such as a tablet computer, or a smart phone). Therefore, as the tablet computer and the smart phone become increasingly popular, a function of the connector 100 is limited severely.

### SUMMARY OF THE INVENTION

An embodiment provides a connector applied to a portable device. The connector includes a wireless module, a connection module, at least one connection socket, a controller, and a memory. The wireless module is used for establishing a wireless connection between the portable device and the connector. The connection module is used for communicating with an external device. The at least one connection socket is used for connecting the connection module with the external device. The controller is coupled between the wireless module and the connection module for transmitting data between the wireless module and the connection module, and for executing commands to control the wireless module and the connection module. The memory is used for storing the commands required for the controller, and being a data register to boost a data transmission rate between the portable device and the external device.

Another embodiment provides a method for connecting a portable device and an external device. The method includes utilizing at least one connection socket of a connector to connect a connection module of the connector with the external device; utilizing a wireless module of the connector to establish a wireless connection between the portable device and the connector; utilizing a controller of the connector to transmit data between the wireless module and the connection module, and execute commands to control the wireless module and the connection module; the controller executing a corresponding operation according to an interrupt command when the controller receives the interrupt command.

The present invention provides a connector applied to a portable device and a method for connecting a portable device and an external device. The connector and the method utilize at least one connection socket to connect a connection module of the connector with the external device, and a wireless module to establish a wireless connection between the portable device and the connector. Therefore, the present invention can be applied to a device without at least one connection socket (such as a tablet computer, or a smart phone), and can enlarge application range of the connector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating operation of a connector according to the prior art.

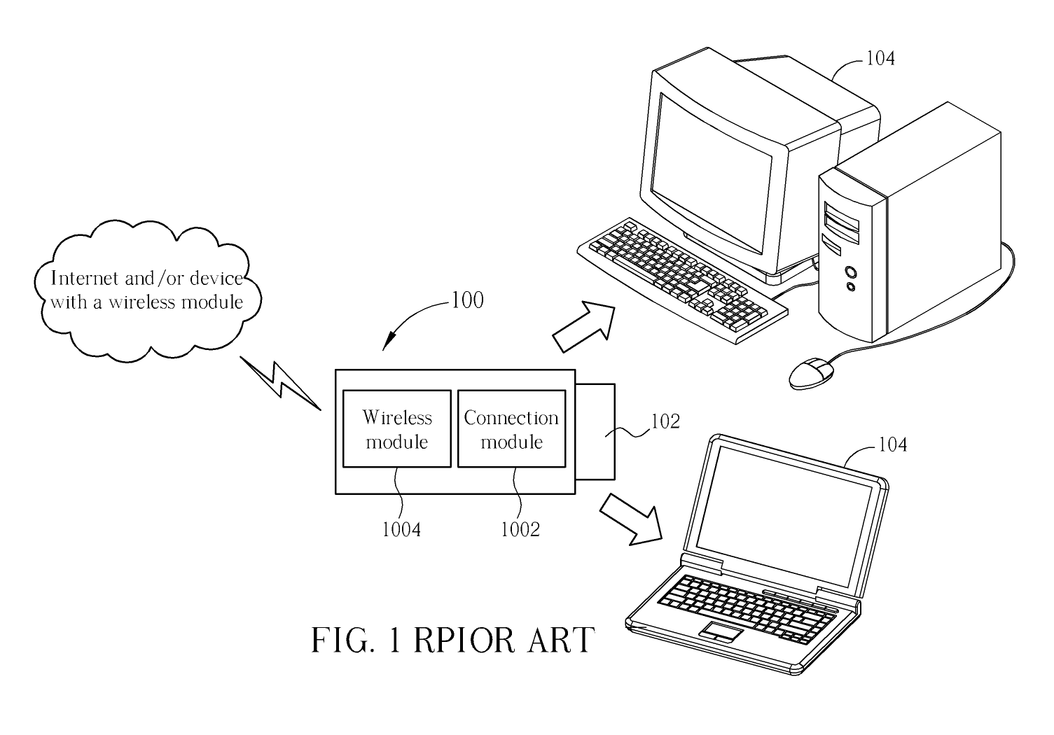

FIG. 2 is a diagram illustrating a connector applied to a portable device according to an embodiment.

FIG. 3 is a flowchart illustrating a method for connecting a portable device and an external device according to another embodiment.

### DETAILED DESCRIPTION

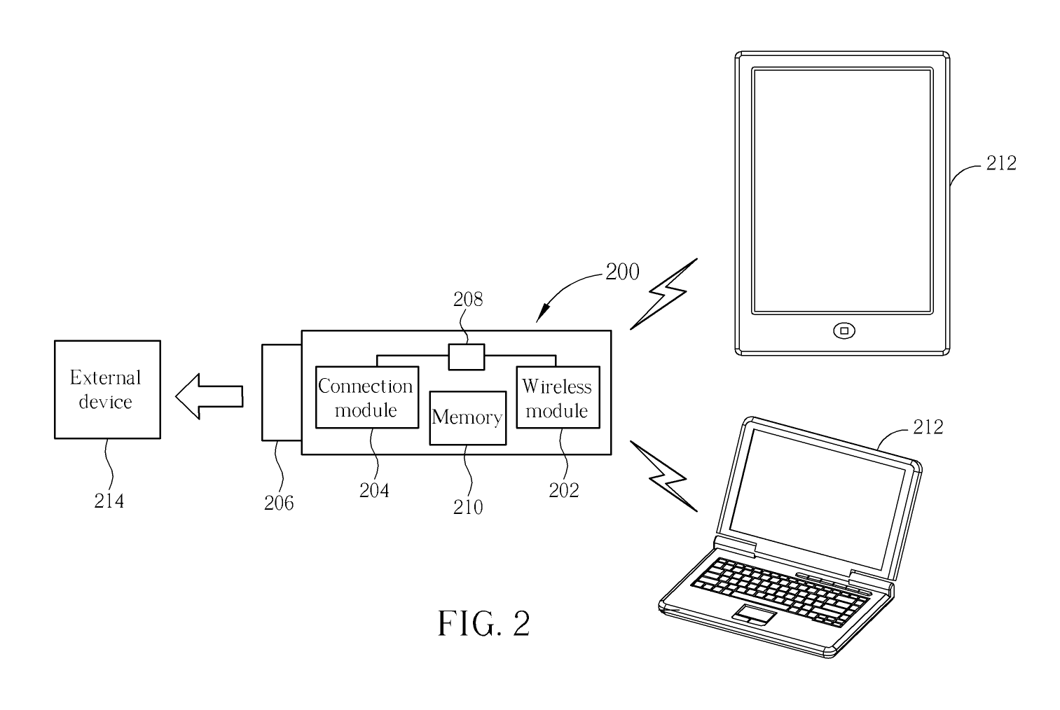

Please refer to FIG. 2. FIG. 2 is a diagram illustrating a connector 200 applied to a portable device according to an embodiment. The connector 200 includes a wireless module 202, a connection module 204, a connection socket 206, a controller 208, and a memory 210. The wireless module 202 is used for establishing a wireless connection between a portable device 212 and the connector 200. The wireless module 202 includes a Bluetooth module, a Wireless Fidelity (Wi-Fi) module, a Worldwide Interoperability for Microwave Access (Wi-Max) module, and/or a Wideband Code Division Multiple Access (WCDMA), and the portable device 212 is a tablet computer, a smart phone, or a netbook. The connection socket 206 is used for connecting the connection module 204 with an external device 214, where the external device 214 is a portable hard drive, a controller of a wireless mouse, or a controller of a wireless keyboard. But, the present invention is not limited to only one connection socket 206. The connection module 204 is used for communicating with the external device 214, where the connection module 204 includes a Universal Serial Bus (USB) connection module, a Serial Advanced Technology Attachment (SATA) connection module, and/or a connection module of a memory card. In addition, when the connection module 204 is the connection module of the memory card, the connection module 204 is a CompactFlash (CF) card connection module, a Secure Digital (SD) card connection module, a miniSD card connection module, a microSD card connection module, and/or a Multimedia Card (MMC card) connection module. The controller 208 is coupled between the wireless module 202 and the connection module 204 for transmitting data between the wireless module 202 and the connection module 204, and for executing commands to control the wireless module 202 and the connection module 204. The memory 210 is used for storing the commands required for the controller 208, storing parameters of programs executed by the controller 208, and being a data register to boost a data transmission rate between the portable device 212 and the external device 214, where the memory 210 is a Dynamic Random Access Memory (DRAM), a Static Random Access Memory (SRAM), a flash memory, or other type memory (such as 1T-SRAM, P-SRAM, FeRAM, MRAM, PCRAM, RRAM and so on). In addition, in another embodiment of the present invention, the connector 200 further includes at least one connection plug.

A function of the connector 200 is that when a user wants to utilize a wireless mouse to control the portable device 212 (a tablet computer), the user can plug the external device 214 (a controller of the wireless mouse with a connection plug) into the connection socket 206 of the connector 200. Thus, the user can utilize the wireless mouse to control the portable device 212 (a tablet computer) through the connector 200. In addition, when the user wants to utilize the portable device 212 (the tablet computer) to store data to the external device 214 (a portable hard drive with a connection plug), the user can plug the portable hard drive into the connection socket 206 of the connector 200. Thus, the user can utilize the portable device 212 (the tablet computer) to store the data to the external device 214 (the portable hard drive).

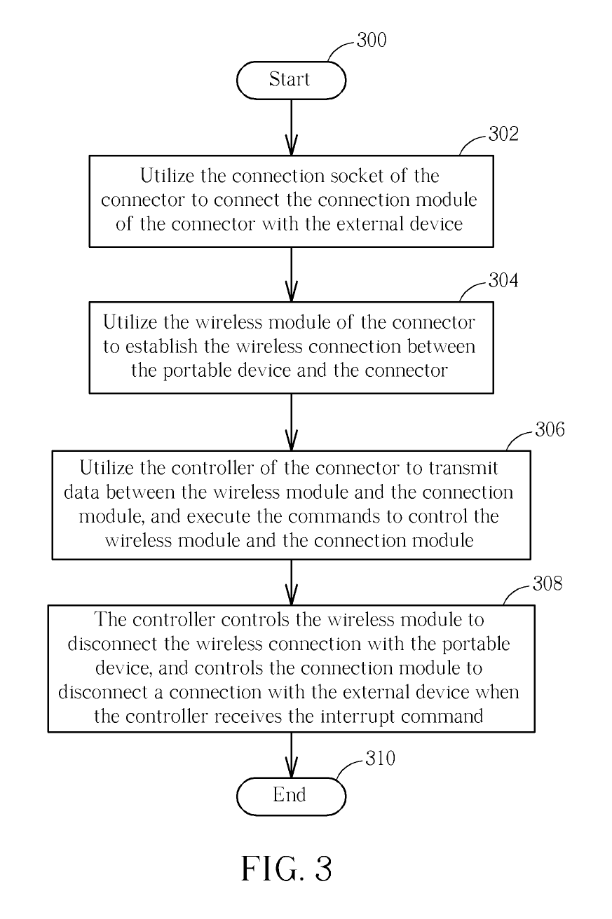

Please refer to FIG. 3. FIG. 3 is a flowchart illustrating a method for connecting a portable device and an external device according to another embodiment. The method in FIG. 3 uses the connector 200 in FIG. 2 to illustrate the method. Detailed steps are as follows:

Step 300: Start.

Step 302: Utilize the connection socket 206 of the connector 200 to connect the connection module 204 of the connector 200 with the external device 214.

Step 304: Utilize the wireless module 202 of the connector 200 to establish the wireless connection between the portable device 212 and the connector 200.

Step 306: Utilize the controller 208 of the connector 200 to transmit data between the wireless module 202 and the connection module 204, and execute the commands to control the wireless module 202 and the connection module 204.

Step 308: The controller 208 controls the wireless module 202 to disconnect the wireless connection with the portable device 212, and controls the connection module 204 to disconnect a connection with the external device 214 when the controller 208 receives the interrupt command.

Step 310: End.

In Step 304, after the controller 208 confirms an account and a password inputted to the portable device 212 by a user, the controller 208 can control the wireless module 202 to establish the wireless connection between the portable devices 212 with the connector 200. In Step 306, the memory 210 is the data register to boost the data transmission rate between the portable device 212 and the external device 214. In Step 308, when the controller 208 receives the interrupt command, the controller 208 controls the wireless module 202 to disconnect the wireless connection with the portable device 212, and controls the connection module 204 to disconnect the connection with the external device 214. In addition, when the controller 208 controls the wireless module 202 to disconnect the wireless connection with the portable device 212, and controls the connection module 204 to disconnect the connection with the external device 214, the controller 208 utilizes the memory 210 of the connector 200 to store the parameters of the programs executed by the controller 208 presently.

To sum up, the connector applied to the portable device and the method for connecting the portable device and the external device utilize at least one connection socket to connect the connection module of the connector with the external device, and the wireless module to establish the wireless connection between the portable device and the connector. Therefore, the present invention can be applied to a device without at least one connection socket (such as the tablet computer, or the smart phone), and can enlarge application range of the connector.

Those skilled in the art will readily observe that numerous modifications and alterations of the device and method may be made while retaining the teachings of the invention.

What is claimed is:

1. A connector applied to a portable device, the connector comprising:
a wireless module for establishing a wireless connection between the portable device and the connector;
a connection module for communicating with an external device;
at least one connection socket for connecting the connection module with the external device;
a controller coupled between the wireless module and the connection module for transmitting data between the wireless module and the connection module, and for executing commands to control the wireless module and the connection module; and
a memory for storing the commands required for the controller, and being a data register to boost a data transmission rate between the portable device and the external device.

2. The connector of claim 1, wherein the wireless module comprises a Bluetooth module, a Wireless Fidelity (Wi-Fi) module, a Worldwide Interoperability for Microwave Access (WiMAX) module, and/or a Wideband Code Division Multiple Access (WCDMA) module.

3. The connector of claim 1, wherein the connection module comprises a Universal Serial Bus (USB) connection module, a Serial Advanced Technology Attachment (SATA) connection module, and/or a connection module of a memory card.

4. The connector of claim 3, wherein the memory card is a CompactFlash (CF) card, a Secure Digital (SD) card, a miniSD card, a microSD card, and/or a Multimedia Card (MMC card).

5. The connector of claim 1, wherein the memory is a Dynamic Random Access Memory (DRAM), a Static Random Access Memory (SRAM), or a flash memory.

6. The connector of claim 1, further comprising at least one connection plug.

7. A method for connecting a portable device and an external device, the method comprising:
utilizing at least one connection socket of a connector to connect a connection module of the connector with the external device;
utilizing a wireless module of the connector to establish a wireless connection between the portable device and the connector;
utilizing a controller of the connector to transmit data between the wireless module and the connection module, and execute commands to control the wireless module and the connection module; and
the controller executing a corresponding operation according to an interrupt command when the controller receives the interrupt command.

8. The method of claim 7, wherein utilizing the wireless module of the connector to establish the wireless connection between the portable device and the connector comprises the controller controlling the wireless module to establish the wireless connection between the portable device and the connector after utilizing the controller to confirm an account and a password inputted into the portable device.

9. The method of claim 7, wherein the controller executing the corresponding operation according to the interrupt command comprises:
the controller controlling the wireless module to interrupt the wireless connection between the portable device and the connector when the controller receives the interrupt command; and
the connection module disconnecting a connection with the external device.

10. The method of claim 9, wherein the controller executing the corresponding operation according to the interrupt command further comprises:
utilizing a memory of the connector to store parameters of programs executed by the controller when the controller controls the wireless module to interrupt the wireless connection between the portable device and the connector, and the connection module disconnects the connection with the external device.
